(19) United States
(12) Patent Application Publication
(10) Pub. No.: US 2005/0198525 A1
(43) Pub. Date: Sep. 8, 2005

(54) System and associated terminal, method and computer program product for conveying context information and providing a context-based service based upon the context information

(75) Inventors: Dirk Trossen, Cambridge, MA (US); Dana Pavel, Cambridge, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/791,555

(22) Filed: Mar. 2, 2004

(51) Int. Cl. G06F 12/14

(52) U.S. Cl. 713/200

(57) ABSTRACT

A system is provided that includes at least one service provider capable of providing at least one context-based service. The system also includes a terminal capable of storing at least one cookie associated with the service provider(s). The terminal is capable of determining an authorization of the service provider(s) to receive context information relating to at least one context of the terminal and/or a terminal user. The terminal can then be capable of inserting, updating and/or deleting context information relating to the context(s) in the cookie(s) associated with each authorized service provider. Thereafter, authorized service provider(s) can be capable of providing context-based services to the terminal based upon the context information included in the cookie(s) associated with the respective service provider(s).

### FIELD OF THE INVENTION

The present invention generally relates to systems and methods of providing context-based services and, more particularly, relates to conveying context information to a provider of context-based services via cookies.

### BACKGROUND OF THE INVENTION

Where mobile telephones were perhaps viewed by many as a luxury when first introduced into the marketplace, they are today viewed by our society as very important, convenient, and useful tools. A great number of people now carry their mobile devices with them wherever they go. This popularity of wireless communication has spawned a multitude of new wireless systems, devices, protocols, etc. Consumer demand for advanced wireless functions and capabilities has also fueled a wide range of technological advances in the utility and capabilities of wireless devices. Wireless/mobile devices not only allow voice communication, but also facilitate messaging, multimedia communications, e-mail, Internet browsing, and access to a wide range of wireless applications and services.

An incredible amount of content, application, services, or the like is already available for use on wireless devices. For example, wireless devices can now access Internet applications such as headline news, exchange rates, sports results, stock quotes, weather forecasts, multilingual phrase dictionaries, personal online calendars, online travel and banking services, or download distinctive ringing tones. Broadband wireless networks make it possible for wireless devices to exchange multimedia messages that combine conventional text with much richer content types, such as photographs, images, voice clips, and video clips. Wireless devices can be used to pay bills online using the wireless device as a virtual wallet. Wireless devices can deliver useful and informative advertising and transaction services from online merchants. Wireless devices now also provide entertainment services, such as interactive adventure games, quizzes, and chess tournaments.

A number of content, applications, services or the like that are available to wireless devices are based upon the environment, or context, of the wireless devices or the users of such mobile devices. For example, location-based services are capable of providing content, such as weather forecasts, to mobile devices based upon the location of mobile devices, and thus the users of such mobile devices. To provide such context-based services in accordance with one conventional technique, a mobile device may request such services from a service provider. Often, the mobile device determines or obtains the context of the mobile device, or user of the mobile device, and includes the context in the request for the context-based service, or in a response to a request for such information from the service provider during the communication session to obtain the context-based service.

Whereas such conventional techniques are adequate in providing context-based services to the mobile device, such conventional techniques have drawbacks. In this regard, in techniques in which a mobile device sends its context in requesting context-based services, the mobile device often includes a number of different pieces of information, one or more of which are unused by the service provider in providing the service. It would therefore be desirable to design a system and method of conveying context information, such as in providing context-based services, in a manner such that the service provider only receives that information necessary to provide the service. It would also be desirable to design such a system that additionally operates without requiring extensions to existing transport protocols (e.g., HTTP) or modifications to existing applications (e.g., client browsers) via which mobile devices receive context-based services. Further, it would be desirable to design such a system that further operates in accordance with authorization policies of a user of the mobile device to thereby protect the user from unauthorized dissemination of context information regarding the user or the mobile device.

### SUMMARY OF THE INVENTION

In light of the foregoing background, the present invention provides an improved system and associated terminal, method and computer program product for conveying context information and providing a context-based service based upon the context information. As explained below, embodiments of the present invention are capable of managing one or more contexts of the terminal or terminal user in a manner such that a service provider can request, and thereafter receive, only that information necessary for providing a context-based service. In this regard, the context(s) are capable of being inserted, updated and/or deleted in cookies that are stored and manipulated at the terminal, and thereafter provided to authorized service providers, such as via a conventional Web browser. As such, in accordance with embodiments of the present invention, context information is capable of being conveyed in a manner that does not require extensions to existing transport protocols, such as Hypertext Transfer Protocol (HTTP).

Also, as various embodiments of the present invention provide a context manager to manage the context(s) of the terminal, conventional Web browsers can typically operate to receive context-based services without modification. Further, in accordance with embodiments of the present invention, an authorization manager is capable of providing one or more authorization policies that can specify the cookies of service provider(s) capable of receiving context information for context(s) of the terminal or terminal user. As such, embodiments of the present invention are capable of operating in a manner that protects the user from unauthorized dissemination of context information regarding the terminal or terminal user.

According to one aspect of the present invention, a system is provided that includes at least one service provider capable of providing at least one context-based service. The system also includes a terminal capable of storing at least one cookie associated with the service provider(s). And in various embodiments, the system can also include an authorization manager capable of storing at least one authorization policy, such as authorization polic(ies) of the terminal or terminal user. The terminal is capable of determining an authorization of the service provider(s) to receive context information relating to at least one context of the terminal and/or a terminal user. The terminal can then be capable of inserting, updating and/or deleting context information relating to the context(s) in the cookie(s) associated with each authorized service provider.

The terminal can be further capable of receiving a trigger to insert, update and/or delete the context information before determining the authorization and inserting, updating and/or deleting the context information. The terminal can then be capable of inserting, updating and/or deleting the context information based upon the trigger. More particularly, in embodiments where the system includes an authorization manager, the terminal can be capable of receiving at least one authorization policy from the authorization manager to thereby determine the authorization of the service provider(s). The terminal can then be capable of receiving a trigger comprising a change in at least one context of the context information, a change in at least one authorization policy, and/or a periodicity.

As indicated above, the service provider(s) are capable of providing context-based service(s). In this regard, the service provider(s) can be capable of requesting, from the terminal, context information relating to at least one context. The terminal, in turn, can be capable of sending the requested context information from a cookie including the requested context information to the service provider(s). More particularly, the terminal can be capable of sending the requested context information when the service provider(s) are authorized to receive the requested context information. The service provider(s) can then be capable of sending a context-based service to the terminal based upon the context information sent to the service provider(s) from the terminal. In various instances, the context information includes an expiration time for at least one context. In such instances, then, the service provider(s) can be capable of sending the context-based service further based upon the expiration time of the context information sent to the service provider(s) from the terminal.

According to other aspects of the present invention, a terminal, method and computer program product are provided. By managing the context(s) of the terminal or terminal user in cookies associated with service providers, embodiments of the present invention are capable of managing contexts in a manner such that a service provider can request, and thereafter receive, only that information necessary for providing a context-based service. Context information can therefore be conveyed in a manner that does not require extensions to existing transport protocols. Also, as indicated above and explained below, cookie(s) associated with each service provider are capable of including context information based upon an authorization of the service provider. Thus, embodiments of the present invention are capable of operating in a manner that protects the user from unauthorized dissemination of context information. Therefore, the system and associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a mobile network and a data network to which a terminal is bi-directionally coupled through wireless RF links;

FIG. 2 is a schematic block diagram of a mobile station that may operate as a terminal, according to embodiments of the present invention;

FIG. 3 is a flowchart illustrating various steps of a method of conveying context information, in accordance with one embodiment of the present invention; and

FIG. 4 is a flowchart illustrating various steps of a method of providing a context-based service, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

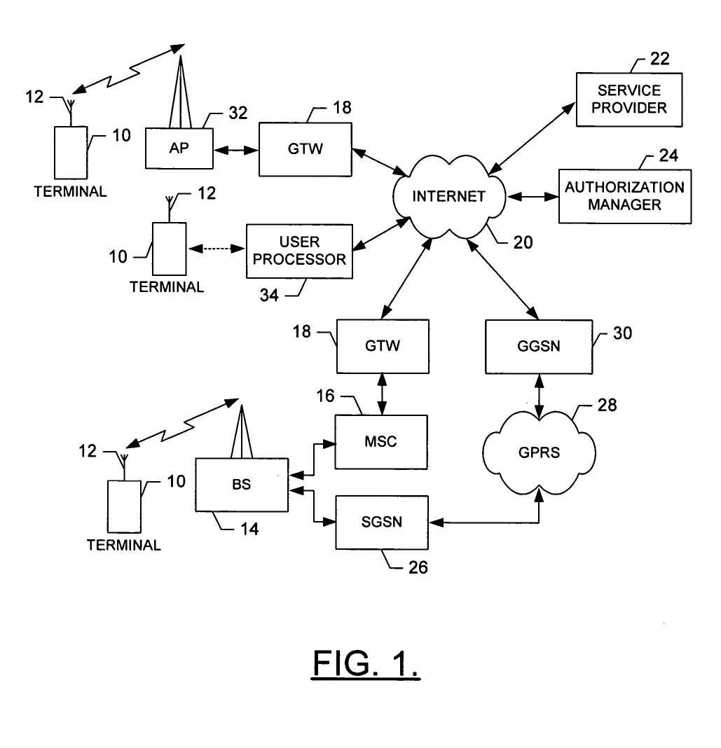

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, a terminal 10 may include an antenna 12 for transmitting signals to and for receiving signals from a base site or base station (BS) 14. The base station is a part of one or more cellular or mobile networks that each include elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also controlling the forwarding of messages for the terminal to and from a messaging center, such as short messaging service (SMS) messages to and from a SMS center (SMSC) (not shown).

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the terminal 10 via the Internet. For example, as explained below, the processing elements can include one or more processing elements associated with a service provider 22, authorization manager 24 or the like, each of which being described in greater detail below.

The BS 14 can also be coupled to a signaling GPRS (General Packet Radio Service) support node (SGSN) 26. As known to those skilled in the art, the SGSN is typically capable of performing functions similar to the MSC 16 for packet-switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 28. The packet-switched core network is then coupled to another GTW, such as a GTW GPRS support node (GGSN) 30, and the GGSN is coupled to the Internet. Also, the GGSN can be coupled to a messaging center, such as a multimedia messaging service (MMS) center (not shown). In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 26 to the GPRS core network 28 and the GGSN 30, processing elements such as service providers 22 and/or authorization managers 24 can be coupled to the terminal 10 via the Internet 20, SGSN and GGSN. In this regard, devices such as service providers and/or authorization managers can communicate with the terminal across the SGSN, GPRS and GGSN. For example, as explained below, service providers can provide context-based services, such as context-based content, to the terminal.

Although not every element of every possible mobile network is shown and described herein, it should be appreciated that the terminal 10 can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The terminal 10 can further be coupled to one or more wireless access points (APs) 32. The APs can comprise access points configured to communicate with the terminal in accordance with techniques such as, for example, radio frequency (RF), Bluetooth (BT), infrared (IrDA) or any of a number of different wireless networking techniques, including WLAN techniques. Additionally, or alternatively, the terminal can be coupled to one or more user processors 34. Each user processor can comprise a computing system such as a personal computer, laptop computer or the like. In this regard, the user processors can be configured to communicate with the terminal in accordance with techniques such as, for example, RF, BT, IrDA or any of a number of different wireline or wireless communication techniques, including LAN and/or WLAN techniques. One or more of the user processors can additionally, or alternatively, include a removable memory capable of storing content, which can thereafter be transferred to the terminal.

The APs 32 and the user processors 34 may be coupled to the Internet 20. Like with the MSC 16, the APs and user processors can be directly coupled to the Internet. In one advantageous embodiment, however, the APs are indirectly coupled to the Internet via a GTW 18. As will be appreciated, by directly or indirectly connecting the terminals 10 and the service providers 22 and/or authorization managers 24, as well as any of a number of other devices, processors or the like, to the Internet, the terminals can communicate with one another, the service provider, etc., to thereby carry out various functions of the terminal, such as to transmit data, content or the like to, and/or receive content, data or the like from, the service providers and/or authorization managers.

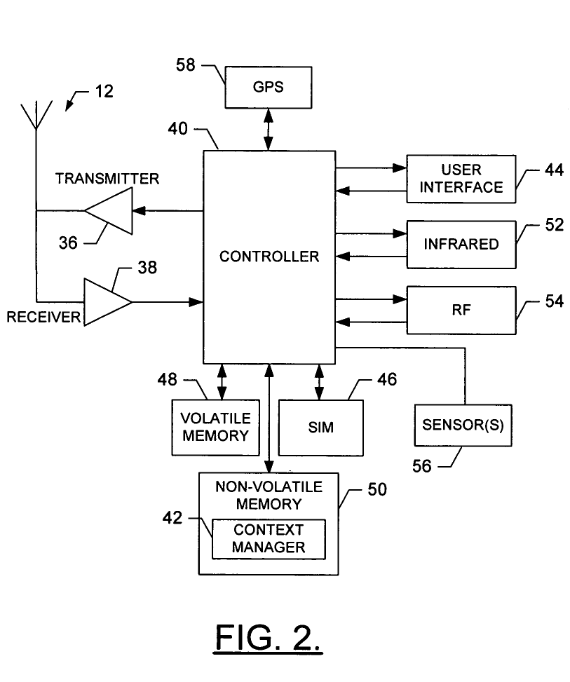

FIG. 2 illustrates a functional diagram of a mobile station that may operate as a terminal 10, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

As shown, the mobile station includes a transmitter 36, a receiver 38, and a processor or controller 40 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, Enhanced Data GSM Environment (EDGE), or the like. Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 40 includes the circuitry required for implementing the audio and logic functions of the mobile station. For example, the controller may be comprised of a digital signal processor device, a microprocessor device, and various analog to digital converters, digital to analog converters, and/or other support circuits. The control and signal processing functions of the mobile station are allocated between these devices according to their respective capabilities. Further, the controller may include the functionally to operate one or more software programs, which may be stored in memory (described below). For example, the controller may be capable of operating a connectivity program, such as a conventional Web browser, that allows the mobile station to transmit and receive Web content, such as according to HTTP, for example. Also, for example, the controller may be capable of operating a context manager 42 capable of managing cookies of the mobile station that are each capable of storing one or more contexts of the mobile station, or more particularly a user of the mobile station, as described in more detail below.

The mobile station also comprises a user interface 44 that may include a conventional earphone or speaker, a ringer, a microphone, a display, and a user input interface, all of which are coupled to the controller 40. The user input interface, which allows the mobile station to receive data, can comprise any of a number of devices allowing the mobile station to receive data, such as a keypad, a touch display (not shown) or other input device. In embodiments including a keypad, the keypad includes the conventional numeric (0-9) and related keys (#, *), and other keys used for operating the mobile station.

The mobile station can also include memory, such as a subscriber identity module (SIM) 46, a removable user identity module (R-UIM) or the like, which typically stores information elements related to a mobile subscriber. In addition to the SIM, the mobile station can include other memory. In this regard, the mobile station can include volatile memory 48, such as volatile Random Access Memory (RAM) including a cache area for the temporary storage of data. The mobile station can also include other non-volatile memory 50, which can be embedded and/or may be removable. The memories can store any of a number of pieces of information, and data, used by the mobile station to implement the functions of the mobile station. For example, the memories can include an identifier, such as an international mobile equipment identification (IMEI) code, capable of uniquely identifying the mobile station, such as to the MSC 16.

Also, for example, the memories 46, 48 and 50 can include connectivity software, such as a conventional Web browser, that allows the mobile station to transmit and receive Web content, such as according to HTTP, for example. Further, for example, the non-volatile memory 50 can store software such as context manager 42, as well as the cookies managed by the context manager, both of which being described in more detail below. As shown and described herein, software such as the context manager comprises software executed by a terminal 10, such as by the controller 40 of the mobile station. It should be understood, however, that the functions of the context manager can equally be implemented in hardware, firmware or the like, without departing from the spirit and scope of the present invention. It should also be understood that although the context manager is shown and described as being co-located with the terminal, the context manager can equally be distributed from the terminal.

The mobile station can further include an infrared transceiver 52 and/or other wireline and/or wireless local data transfer devices so that data can be shared with and/or obtained from other electronic devices, such as other mobile stations, car guidance systems, personal computers, printers, printed materials including barcodes and the like. The sharing of data, as well as the remote sharing of data, can also be provided according to a number of different techniques. For example, the mobile station may include a radio frequency transceiver 54 capable of sharing data with other radio frequency transceivers, and/or with a Radio Frequency Identification (RFID) transponder tag, as such is known to those skilled in the art. Additionally, or alternatively, for example, the mobile station may share data using Bluetooth brand wireless technology developed by the Bluetooth Special Interest Group. Further, although not shown, the mobile station may share data using universal serial bus (USB) technology.

The mobile station may also have one or more sensors 56 for sensing the ambient conditions of the mobile user and, more particularly, the mobile station operated by, or otherwise under the control of, the mobile user. In this regard, the mobile station may include sensors such as, for example, a positioning sensor, a touch sensor, an audio sensor, a compass sensor, an ambient light sensor, an ambient temperature sensor and/or a two or three-axis acceleration sensor. The audio sensor can comprise a microphone as part of the user interface 44, for example, which can detect speech or environmental sounds. The positioning sensor can comprise, for example, a GPS sensor 58. Additionally, or alternatively, the positioning sensor can comprise, for example, a radio beacon triangulation sensor that determines the location of the wireless device by means of a network of radio beacons, base stations, or access points, as is described for example, in Nokia European patent EP 0 767 594 A3, entitled: Mobile Station Positioning System, published on May 12, 1999, the contents of which are hereby incorporated by reference in its entirety.

As will be appreciated, the sensors 56 can also be located in accessory-like mobile station covers and/or in a wireless accessory such as a Bluetooth-enabled device. The sensors may further be located in the environment such as in the user's rooms or vehicles, with data collected by such sensors being transferred to the mobile station. Also, information capable of being measured by the mobile station, such as the time duration of use of the mobile station, can be received as sensor data by the mobile station. For more information on such sensors, see U.S. patent application Ser. No. 09/854,628, entitled: Context Sensitive Web Services, filed May 15, 2001, which published on Nov. 21, 2002 as U.S. Patent Application Publication No. 2002/0173295, the contents of which is hereby incorporated by reference in its entirety.

As indicated in the background section, in conventional techniques for providing context-based services to mobile devices such as terminals 10, the terminal can send its context or the context of the terminal user in requesting context-based services, where the context can include a number of different pieces of information. In this regard, one or more of the pieces of information sent in a request for context-based services may be unused by the service provider in providing the service. Thus, in accordance with embodiments of the present invention, the terminal is capable of operating a context manager 42 that manages one or more contexts of the terminal or terminal user in a manner such that a service provider can request, and thereafter receive, only that information necessary for providing a context-based service.

As explained below, the context manager 42 is capable of managing the context(s) of the terminal 10 within cookies that are capable of being stored and manipulated at the terminal, where the context(s) are capable of thereafter being provided to a service provider, such as via a conventional Web browser. As such, the context manager is capable of conveying context information in a manner that does not require extensions to existing transport protocols, such as Hypertext Transfer Protocol (HTTP). Also, by providing the context manager to manage the context(s) of the terminal, conventional Web browsers can typically operate to receive context-based services without modification. Further, the context manager is capable of communicating with an authorization manager 24, which includes one or more authorization policies of a terminal user. In this regard, the context manager can protect the user from unauthorized dissemination of context information regarding the terminal or terminal user.

As will be appreciated by those skilled in the art, transactions across networks such as the Internet are typically stateless in that a state of a client with respect to a server is typically not carried over from one transaction to another. However, techniques have been developed in which the client is “marked” by the server, such as during an initial communication transaction between the client and the server. This marking, then, can function as state information regarding the client for subsequent transactions between the client and server. In one typical technique of “marking” clients, electronic files often referred to as cookies are locally stored by the client upon request by the server. A cookie can be defined as information stored in memory of the client that specifies the client in some manner to the server. Then, when the client again communicates with the server, the server can request, and thereafter receive information from, any cookie that identifies the client to the server.

In accordance with embodiments of the present invention, the context manager 42 is capable storing one or more cookies in memory (e.g., non-volatile memory 50) of the terminal 10, where each cookie includes context information relating to the terminal, or the terminal user. Each cookie can include any of a number of different pieces of information formatted in any of a number of different manners. More particularly, for example, each cookie can comprise a text-only string that is either human readable or encrypted. When a cookie is human readable, then, the context manager can be capable of appending context information to the cookie, such as in attribute-values or more complex resource description format (RDF)-based notations (e.g., to encode distribution and detention rules for such context information). When a cookie is encrypted, on the other hand, the context manager can be capable of decrypting the cookie, appending context information to the cookie, and thereafter re-encrypting the cookie.

The context information stored in each cookie can comprise any of a number of different pieces of information relating to the environment, or context, of the terminal 10 or the terminal user. In this regard, context information can be obtained, for example, from one or more sensors (e.g., sensor(s) 56, GPS sensor 58) local to or remote from the terminal. For example, context information can comprise information relating to a location of the terminal or terminal user, and/or a temperature and/or amount of ambient light in the environment of the terminal or terminal user. In addition, context information can comprise higher-level information, such as presence, activity, effective state and/or availability of the terminal or terminal user, as such may be derived from information obtained from one or more sensors. Further, context information can comprise preferences, such as preferred topics for content delivery derived from the location of the terminal or terminal user, where such information may be derived from information obtained, or derived from, sensors. For other examples of context information and techniques for obtaining such context information, see U.S. patent application Ser. No. 09/854,628, which discloses a context-inference engine capable of identifying one or more contexts of a terminal or terminal user.

In addition to information relating to the context of the terminal 10 or terminal user, the context information can also include one or more rules regarding the distribution and retention policies for the particular contexts. Further, the context information can include an expiration time for the respective context. The expiration time comprises an absolute and/or relative time that typically defines a period of time the respective context information is valid. For example, the expiration time can comprise an absolute time, such as 4:00 PM, Oct. 2, 2003. Also, for example, the expiration time can comprise a relative time, such as five days, along with the absolute time the context was stored in the respective cookie.

In accordance with embodiments of the present invention, the context manager 42 is capable of storing one or more cookies associated with one or more service providers 22, where each cookie includes context information relating to one or more different contexts of the terminal 10 or terminal user. More particularly, the context manager is capable of storing, for each service provider, a cookie that includes context information relating to one or more contexts. Alternatively, for one or more service providers, the context manager can be capable of storing a plurality of cookies, where each cookie includes context information relating to a respective context. The cookie(s) for each service provider, then, can include context information relating to one or more contexts of the terminal or terminal user capable of being provided to the respective service provider. Alternatively, the cookie(s) for one or more service providers can include context information relating to only those contexts typically utilized by the service provider(s) in providing respective context-based service(s).

Advantageously, the context manager 42 can be capable of including context information relating to one or more contexts within the cookie(s) of the service provider(s) 22 in accordance with one or more authorization policies, which may be stored by an authorization manager 24 supporting the terminal 10. In this regard, the context manager can be capable of including context information for one or more contexts in the cookie(s) of service provider(s) authorized to receive context information for such context(s), as specified or otherwise permitted based upon the authorization polic(ies) stored by the authorization manager. For those service provider(s) not authorized to receive context information for one or more contexts, however, the context manager can be capable of reacting in any of a number of different manners. For example, the context manager can store default context information for such context(s) in the cookie(s) of the unauthorized service provider(s), where the default context information may indicate that context information for such context(s) is unavailable. Alternatively, for one or more service provider(s), the context manager can store context information for one or more contexts in the cookie(s) of the unauthorized service provider(s) but read-protect, or otherwise prevent the unauthorized service provider(s) from receiving, the respective context information.

As will be appreciated, at one or more instances, context information for one or more of the contexts of the terminal 10 or terminal user, and/or one or more authorization polic(ies) of the terminal or terminal user, may change. In such instances, the context manager 42 can be capable of updating the context information included in the cookie(s) of the service provider(s) in accordance with the updated context information and/or updated authorization polic(ies). Additionally, or alternatively, the context manager can be capable of updating the context information for one or more contexts periodically and/or at one or more specified times.

The context manager 42 can receive changes to one or more contexts of the terminal 10 or terminal user in any of a number of different manners. For example, the context manager can be capable of receiving changes from sensors (e.g., sensor(s) 56, GPS sensor 58, etc.), and/or from a context-inference engine such as that disclosed by U.S. patent application Ser. No. 09/854,628. Additionally, or alternatively, the context manager can be capable of receiving changes to one or more authorization policies of the terminal 10, such as by periodically polling the authorization manager 24 for such changes, and/or configuring the authorization manager to automatically send such changes to the context manager periodically or in real-time as the changes occur, such as in a manner in accordance with XCAP. For a more detailed description of XCAP, see Internet Engineering Task Force (IETF), Extensible Markup Language (XML) Configuration Access Protocol (XCAP), Internet draft document draft-ietf-simple-xcap-01 (2003), the contents of which are hereby incorporated by reference in its entirety).

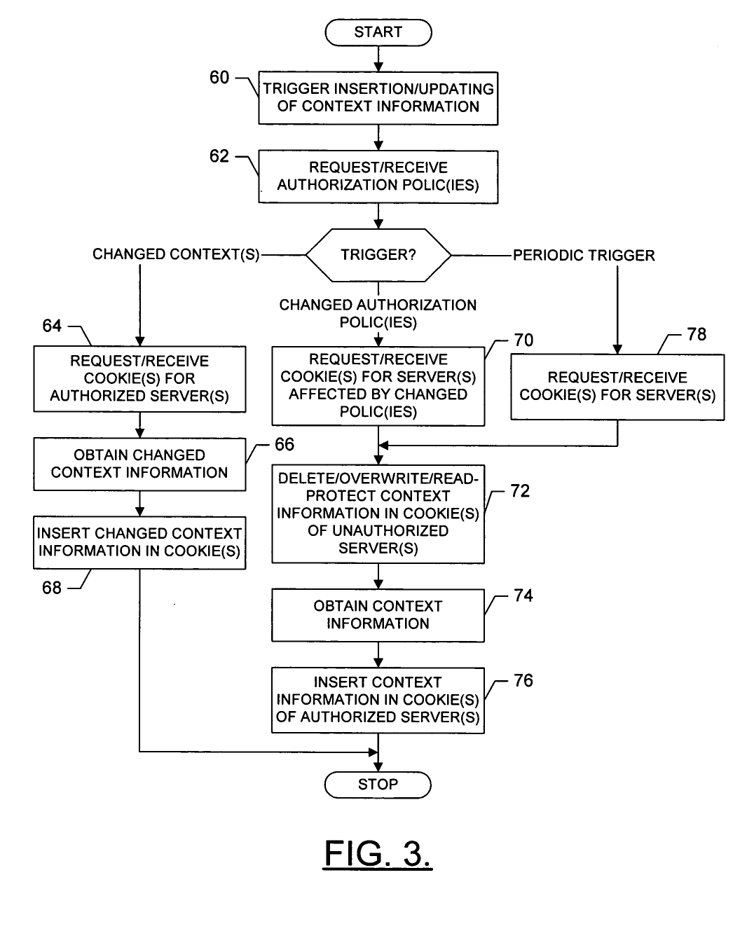

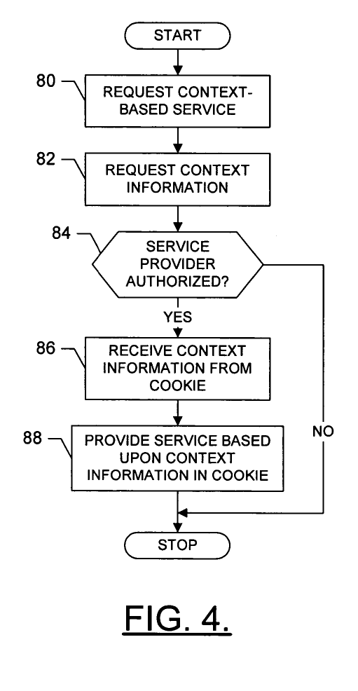

Reference is now made to FIGS. 3 and 4, which illustrate flowcharts of methods of conveying context information and providing a context-based service, respectively, in accordance with embodiments of the present invention. As described below, the context manager 42 communicates with the terminal 10, such as in instances in which the context manager is distributed from the terminal. It should be understood, however, that in instances in which the terminal is capable of operating the context manager, the communications between the terminal and context manager are internal to the terminal and occur between the context manager and appropriate components of the terminal (e.g., non-volatile memory 50). Also, as described below, the terminal stores cookie(s) for one or more service providers 22, such as in memory of the terminal. It should also be understood, however, that the context manager can be capable of generating or receiving, and thereafter storing, the respective cookie(s) at one or more different points during operation of the context manager, without departing from the spirit and scope of the present invention.

As shown in block 60 of FIG. 3, a method of conveying context information includes the context manager 42 being triggered to insert, update and/or delete context information in the cookie(s) of one or more service providers 22, such as to insert, update and/or delete the context information for a particular context (e.g., location) of the terminal 10 or terminal user. The context manager can be triggered in any of a number of different manners. For example, the context manager can be triggered by changes to one or more contexts of the terminal or terminal user, changes in one or more authorization policies, and/or a periodicity. Irrespective of how the context manager is triggered to insert, update and/or delete context information in the cookie(s) of one or more service providers, however, after being triggered, the context manager can communicate with an authorization manager 24 to receive the authorization polic(ies) of the terminal or terminal user, as shown in block 62. In this regard, the authorization polic(ies) can specify or otherwise indicate one or more service providers permitted to receive context information relating to one or more contexts based upon the authorization polic(ies) stored by the authorization manager. As such, the context manager can identify those service providers that are authorized and/or unauthorized to receive one or more contexts of the terminal or terminal user.

After identifying authorized and/or unauthorized service provider(s) 22 for the context(s) of the terminal 10 or terminal user, when the context manager 42 is triggered by changes to one or more contexts of the terminal or terminal user, the context manager can request, and thereafter receive, the cookie(s) of the authorized service provider(s) from the terminal (e.g., non-volatile memory 50), as shown in block 64. More particularly, the context manager can request, and thereafter receive, the cookie(s) storing context information of the changed context(s). Then, as shown in block 66, the context manager can receive the changed context(s), such as from one or more sensors (e.g., sensor(s) 56, GPS sensor 58) of the terminal, and/or from a context-inference engine. Alternatively, the context manager can receive the changed context(s) in the trigger (see block 60) that indicated such changes. The context manager can thereafter update context information relating to the changed context(s) in the respective cookie(s) of the authorized service provider(s), as shown in block 68.

When the context manager 42 is triggered by changes in one or more authorization policies, the context manager can request, and thereafter receive, the cookie(s) of the service provider(s) 22 affected by the changed polic(ies), as shown in block 70. More particularly, the context manager can receive the cookie(s) of service provider(s) whose authorization changed from authorized to unauthorized, or vice versa, with respect to receiving context information for one or more contexts of the terminal 10 or terminal user. Thereafter, as shown in block 72, for those service provider(s) whose authorization changed from authorized to unauthorized, the context manager can delete the context information for the respective context(s). Alternatively, the context manager can overwrite the context information with default context information, read-protect or otherwise prevent the respective service provider(s) from receiving the context information for the respective context(s). On the other hand, for those service provider(s) whose authorization changed from unauthorized to authorized, the context manager can obtain the respective context(s), as shown in block 74. The context manager can then insert context information relating to the obtained context(s) in the cookie(s) of the respective service provider(s), as shown in block 76.

When the context manager 42 is periodically triggered to insert, update and/or delete context information for one or more contexts in the cookie(s) of one or more service provider(s) 22, the context manager can request, and thereafter receive, the cookie(s) of the service provider(s) 22 from the terminal, as shown in block 78. In contrast to when the context manager is triggered by changes to one or more contexts, or one or more authorization policies, when the context manager is periodically triggered, the context manager can receive the cookie(s) of the service provider(s) without regard to whether the service provider(s) are authorized, or whether the service provider(s) have been affected by changes to authorization polic(ies). As shown again in block 72, for any service provider(s) whose authorization has changed from authorized to unauthorized, the context manager can delete, overwrite or read-protect the context information for the respective context(s). For the remaining service provider(s), including any service provider(s) whose authorization has changed from unauthorized to authorized, the context manager can obtain the context information for the respective context(s), as shown again in block 74. Then, as illustrated in block 76, the context manager can insert the obtained context information in the cookie(s) of the respective service provider(s), such as in a manner without regard to whether the context information has changed.

As described above, the context manager 42 can be triggered, for example, by changes to one or more contexts of the terminal 10 or terminal user, changes in one or more authorization policies, and/or a periodicity. The context manager can then respond to insert, update and/or delete context information in the cookie(s) of one or more service providers 22 based upon the trigger. As will be appreciated, in various instances, the context manager can be triggered by more than one of context changes, authorization policy changes, and periodic triggering. For example, in various instances, the context manager can be triggered by both context changes and authorization policy changes. In such instances, the context manager can respond in a manner consistent with the manner the context manager responds to each trigger individually.

As explained above, the context manager 24 can operate in different manners based upon the trigger. It should be understood, however, that the context manager can be configured to respond to each trigger in the same manner. For example, irrespective of whether the context manager is triggered by changes to one or more contexts of the terminal 10 or terminal user, changes in one or more authorization policies, and/or a periodicity, the context manager can operate in a manner consistent with when the context manager is periodically triggered. In such instances, the context manager can be capable of being triggered without knowledge of the nature of the trigger, whether the trigger is based upon changes to one or more contexts of the terminal 10 or terminal user, changes in one or more authorization policies, and/or a periodicity.

At any point after storing the cookie(s) of one or more service providers 22, the respective service provider(s) can be capable of providing a context-based service to the terminal based upon the context information included in the respective cookie(s). In accordance with one embodiment of the present invention, as shown in FIG. 4, a method of providing a context-based service includes a terminal 10 requesting a context-based service from a service provider, such as from within a conventional Web browser application operating on the terminal, as shown in block 80. As will be appreciated, the request for a context-based service can occur at any point prior to receiving the context-based service. For example, the request can be sent to the service provider as part of a transaction in which the service provider provides the requested service. Additionally, or alternatively, the request can be sent to the service provider such that the service provider provides the requested service at one or more points in time after the request.

Irrespective of exactly when the service provider 22 receives a request for a context-based service, after receiving the request, as shown in block 82, the service provider can request context information relating to a context of the terminal 10 or terminal user forming the basis of the context-based service, where the context information is included within a cookie associated with the service provider stored in memory (e.g., non-volatile memory 50) of the terminal. The service provider can request the context information in any of a number of different manners. For example, the service provider can request the context information by communicating with JavaScript™ scripts stored in memory of the terminal and executable by the terminal (e.g., controller 40) at the direction of the service provider.

After requesting the context information from a cookie associated with the service provider 22, the terminal 10 can send the requested context information to the service provider, such as at the direction of JavaScript™ scripts, if the service provider is authorized to receive such context information, as shown in blocks 84 and 86. Although the service provider typically requests the context information, it should be understood that the terminal can send the context information to the service provider independent of a request for such context information from the service provider, again provided the service provider is authorized to receive such context information. In this regard, the terminal can send the context information to the service provider within a request for a respective context-based service.

Because the cookie(s) of service provider(s) 22 include context information relating to context(s) based upon whether the respective service provider(s) are authorized to receive such context(s), the service provider can be identified as being authorized or unauthorized based upon whether a cookie associated with the service provider includes the requested context information. If a cookie of the service provider does not include the requested context information, or if the requested context information is read-protected or has default context information stored in place of the requested context information, the service provider can be prevented from receiving the requested context information from the terminal. In such instances, the service provider can be prevented from providing the requested context-based service based upon the requested context information.

As shown in block 88, upon receipt of the requested context information, the service provider 22 can provide the requested context-based service to the terminal 10. Before providing the requested context-based service, the service provider can examine the expiration time of the received context information. If the expiration time has lapsed, the service provider can respond in a number of different manners, such as by notifying the terminal of the expired context information. In such instances, if so desired, the terminal may be configured to receive the notification of the expired context information as a trigger to insert, update and/or delete context information in the respective cookie. If the expiration time of the context information has not lapsed, however, the service provider can provide the requested context-based service in any of a number of different known manners. For example, the service provider can provide the context-based service via a conventional Web browser operating on the terminal.

As an example scenario of a terminal 10 operating to receive a context-based service in accordance with an embodiment of the present invention, consider a user directing the terminal to operate a Web browser to access the Web page “http://www.weather.com.” The Web page, in turn, is operated by a service provider 22 that provides weather forecasts for a given city in the United States. To provide the forecasts, however, the service provider requests a current location of the terminal user, such as a city or zip-code location of the user. Assuming the service provider is authorized to receive a location of the terminal, the context manager 42 can insert a zip code-level location of the terminal in a cookie associated with the service provider, where the location of the terminal can be updated such as in any of a number of different manners described above. Communicating with embedded JavaScript™ scripts, then, the service provider can receive the location of the terminal from the cookie storing the zip code-level location of the terminal. Thereafter, the service provider can provide, to the terminal, the weather forecast for the current zip code location of the terminal.

According to one aspect of the present invention, all or a portion of the system of the present invention, such as all or portions of the terminal 10, service provider 22, and/or authorization manager 24, generally operates under control of a computer program product (e.g., context manager 42). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 3 and 4 are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowcharts block(s) or step(s).

Accordingly, blocks or steps of the flowcharts supports combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system comprising:
at least one service provider capable of providing at least one context-based service; and
a terminal capable of storing at least one cookie associated with the at least one service provider, wherein the terminal is also capable of determining an authorization of the at least one service provider to receive context information relating to at least one context of at least one of the terminal and a terminal user, and wherein the terminal is capable of at least one of inserting, updating and deleting context information relating to the at least one context in the at least one cookie associated with each authorized service provider.

2. A system according to claim 1, wherein the terminal is further capable of receiving a trigger to at least one of insert, update and delete context information before determining the authorization and at least one of inserting, updating and deleting the context information.

3. A system according to claim 2, wherein the terminal is capable of at least one of inserting, updating and deleting context information based upon the trigger.

4. A system according to claim 3 further comprising:
an authorization manager capable of storing at least one authorization policy,
wherein the terminal is capable of receiving at least one authorization policy from the authorization manager to thereby determine the authorization of the at least one service provider, and wherein the terminal is capable of receiving a trigger comprising at least one of a change in at least one context of the context information, a change in at least one authorization policy, and a periodicity.

5. A system according to claim 1, wherein the at least one service provider is capable of requesting, from the terminal, context information relating to at least one context, wherein the terminal is capable of sending the requested context information from a cookie including the requested context information to the at least one service provider, wherein the terminal is capable of sending the requested context information when the at least one service provider is authorized to receive the requested context information, and wherein the at least one service provider is capable of sending a context-based service to the terminal based upon the context information sent to the at least one service provider from the terminal.

6. A system according to claim 5, wherein the context information includes an expiration time for at least one context, and wherein the at least one service provider is capable of sending the context-based service further based upon the expiration time of the context information sent to the at least one service provider from the terminal.

7. A terminal comprising:
a memory capable of storing at least one cookie associated with at least one service provider; and
a controller capable of communicating with a context manager, wherein the context manager is capable of determining an authorization of the at least one service provider to receive context information relating to at least one context of at least one of the terminal and a terminal user, and wherein the context manager is also capable of at least one of inserting, updating and deleting context information relating to the at least one context in the at least one cookie associated with each authorized service provider.

8. A terminal according to claim 7, wherein the context manager is capable of receiving a trigger to at least one of insert, update and delete context information before determining the authorization of the at least one service provider and at least one of inserting, updating and deleting the context information.

9. A terminal according to claim 8, wherein the context manager is capable of at least one of inserting, updating and deleting context information based upon the trigger.

10. A terminal according to claim 9, wherein the context manager is capable of determining an authorization based upon at least one authorization policy, and wherein the context manager is capable of receiving a trigger comprising at least one of a change in at least one context of the context information, a change in at least one authorization policy, and a periodicity.

11. A terminal according to claim 7, wherein the controller is capable of receiving a request for context information relating to at least one context, and thereafter sending the requested context information from a cookie including the requested context information to the at least one service provider, wherein the controller is capable of sending the requested context information when the at least one service provider is authorized to receive the requested context information, and wherein the controller is capable of receiving a context-based service from the at least one service provider based upon the context information sent to the at least one service provider.

12. A terminal according to claim 11, wherein the context information includes an expiration time for at least one context, and wherein the controller is capable of receiving the context-based service from the at least one service provider further based upon the expiration time of the context information sent to the at least one service provider.

13. A method comprising:
storing, in memory of a terminal, at least one cookie associated with at least one service provider;
determining an authorization of the at least one service provider to receive context information relating to at least one context of at least one of a terminal and a terminal user; and at least one of
inserting, updating and deleting context information relating to the at least one context in the at least one cookie associated with each authorized service provider.

14. A method according to claim 13 further comprising:
triggering at least one of the insertion, updating and deletion of the context information before determining an authorization and at least one of inserting, updating and deleting context information.

15. A method according to claim 14, wherein at least one of inserting, updating and deleting context information comprises at least one of inserting, updating and deleting context information based upon triggering at least one of the insertion, updating and deletion.

16. A method according to claim 15, wherein determining an authorization comprises determining an authorization based upon at least one authorization policy, and wherein at least one of inserting, updating and deleting context information based upon triggering at least one of the insertion, updating and deletion comprises at least one of inserting, updating and deleting context information based upon at least one of a change in at least one context of the context information, a change in at least one authorization policy, and a periodicity.

17. A method according to claim 13 further comprising:
receiving, from a service provider, a request for context information relating to at least one context;
sending the requested context information from a cookie including the requested context information to the at least one service provider, wherein the requested context information is sent when the at least one service provider is authorized to receive the requested context information; and
receiving a context-based service from the at least one service provider based upon the context information sent to the at least one service provider.

18. A method according to claim 17, wherein the context information includes an expiration time for at least one context, and wherein receiving a context-based service comprises receiving a context-based service from the at least one service provider further based upon the expiration time of the context information sent to the at least one service provider.

19. A computer program product comprising a computer-readable storage medium having computer-readable program code portions stored therein, the computer-readable program code portions comprising:
a first executable portion for storing, in memory of a terminal, at least one cookie associated with at least one service provider;
a second executable portion for determining an authorization of the at least one service provider to receive context information relating to at least one context of at least one of a terminal and a terminal user; and
a third executable portion for at least one of inserting, updating and deleting context information relating to the at least one context in the at least one cookie associated with each authorized service provider.

20. A computer program product according to claim 19 further comprising:
a fourth executable portion for triggering at least one of the insertion, updating and deletion of the context information before the second executable portion determines the authorization and the third executable portion at least one of inserts, updates and deletes the context information.

21. A computer program product according to claim 20, wherein the third executable portion is adapted to at least one of insert, update and delete the context information based upon the fourth executable portion triggering at least one of the insertion, updating and deletion.

22. A computer program product according to claim 21, wherein the second executable portion is adapted to determining the authorization based upon at least one authorization policy, and wherein the third executable portion is adapted to at least one of insert, update and delete the context information based upon at least one of a change in at least one context of the context information, a change in at least one authorization policy, and a periodicity.

23. A computer program product according to claim 19 further comprising:
a fourth executable portion for receiving, from a service provider, a request for context information relating to at least one context;
a fifth executable portion for sending the requested context information from a cookie including the requested context information to the at least one service provider, wherein the requested context information is sent when the at least one service provider is authorized to receive the requested context information; and
a sixth executable portion for receiving a context-based service from the at least one service provider based upon the context information sent to the at least one service provider.

24. A computer program product according to claim 23, wherein the context information includes an expiration time for at least one context, and wherein the sixth executable portion is adapted to receive the context-based service from the at least one service provider further based upon the expiration time of the context information sent to the at least one service provider.
